(19) United States
(12) Patent Application Publication
(10) Pub. No.: US 2021/0017778 A1
(43) Pub. Date: Jan. 21, 2021

(54) ROOFING GUARD FOR CARPENTERS

(71) Applicants: Rino Phillippe ALBERT, Scarborough, CA (US); Matthew Oniel ALBERT, Scarborough, CA (US)

(72) Inventors: Rino Phillippe ALBERT, Scarborough, CA (US); Matthew Oniel ALBERT, Scarborough, CA (US)

(21) Appl. No.: 16/931,667

(22) Filed: Jul. 17, 2020

Related U.S. Application Data
(63) Continuation-in-part of application No. 16/516,446, filed on Jul. 19, 2019.

(30) Foreign Application Priority Data
Jul. 19, 2019 (CA) 3050157

(51) Int. Cl. E04G 21/32; E04G 5/04

(52) U.S. Cl. CPC E04G 21/3214; E04G 5/041

(57) ABSTRACT

In various aspects and embodiments a roofing guard device 200, 202 comprises a mount portion 210, optional brace portion 220, lateral supports 240, restraint flanges 214, 216, and fencing post 275 for engagement of fencing panels 300, as well as optional fall-arrest mount 230. By securely supporting fencing 300 and optional foot braces 12, the roofing guard device 200, 202 and corresponding roofing systems reduce the likelihood of workers or materials falling from roofs or other high places.

### FIELD OF THE INVENTION

The invention relates to devices for improved roofing safety, and particularly to improved devices used for installing, maintaining, and repairing sloped Roofs.

### BACKGROUND

Work that involves roofing has long been known to be a dangerous occupation. Slips, falls, injuries and deaths are too common. A number of solutions have previously been proposed, yet problems persist with respect to both safety and the contributions of the solutions to efficiency in getting the job done.

For example, the bracket shown in FIGS. 1 and 2, though it represented a substantial improvement over previous devices, suffers from at least three significant problems: (1) the security of the foot guard 12 when supported by the brackets 900; (2) the creation of a gap 910 between the edge 101 of the roofing surface 100 and the lower edge 14 of the side 16 of the foot guard 12 adjacent the worker's foot 92 when the bracket is installed; and (3) lack of any means for the worker 90 to secure a personnel safety device, such as a restraining harness, to the bracket 900.

As a result of these shortcomings, the foot guard 12 is likely to slip upward along the support portion 912 of the bracket 900, in the direction of the arrows 905, even if the worker 90 is constantly vigilant to avoid shifting it, potentially causing both the foot guard 12 and the worker 90 to fall from the roof, creating a hazard not only for the falling worker and any tools he/she may be working with, but for anything that might be below—including passersby.

Moreover, the presence of the gap 910 means that if the worker drops any hammers or other tools or hardware, they are likely to slide along the roof to the gap 910, fall between the roof 100 and the foot guard 12, and endanger anything and anyone below.

And the absence of any means for securing himself to the roofing bracket, via a personnel restraint device, means that the worker 90 is in constant danger of falling from the roof to whatever happens to be below.

It is also noted that the height of prior-art safety devices, while adequate for engaging feet or footwear of roofing workers and adding a significant measure of safety, is in some situations insufficient to protect a worker, his/her tools, and or various work materials from toppling over or otherwise falling past the foot guard or other restraint component onto whatever happens to be below.

In its various aspects, the invention disclosed herein addresses these problems, and offers further advantages.

### SUMMARY OF THE INVENTION

In various aspects and embodiments the invention provides improved devices for roofing or other construction or maintenance or use of high places. In particular, the invention provides improved roofing guard devices configured for permanent or releasable attachment to roofing surfaces, in order to provide permanent or removable support, with greater reliability, for foot guards such as 2″×4″, 2″×6″, or other boards in such manner as to help prevent carpenters, shinglers, and other roofing workers from falling from rooftops.

For example, in one aspect the invention provides a roofing guard device, such as a bracket, comprising at least a mount portion, a foot-guard brace portion, and a fall-arrest safety mount. The mount portion can be adapted for permanent or releasable and in all cases secure, attachment, e.g., by means of nails or screws, to a roofing surface, such as a plywood or other wooden substrate, for example. The foot-guard brace portion can be adapted to permanently or releasably support a foot guard in a generally orthogonal relationship with respect to the roofing surface. For secure support of the foot guard, the foot-guard brace can include a retainer flange adapted to firmly restrain the foot guard from moving away from the foot-guard brace or the roof, in order to ensure that a worker on the roof might is not deprived of needed support.

Fall-arrest safety mounts in accordance with such embodiments can be adapted for permanent or releasable attachment of one or more personnel fall arrest devices, such as safety straps or safety lines, and can be provided on either or both of the mount portion and the foot-guard brace portion. As described below, a very wide variety of fall-arrest safety mounts can be provided, for cooperation with a very wide variety of personnel safety devices, such as restraining straps.

In various embodiments, roofing guard devices in accordance with the invention can include one or more lateral braces configured to extend away from sides of the mounting portion, in order to provide greater stability to the roofing guard device, and therefore increased roofer safety. In such embodiments, the mount portion and the foot-guard brace portion can be integrally formed of flat sheet or bar stock.

Among the additional improvements offered by various aspects and embodiments of the invention is placement of lateral brace(s) as described above, one on either side of the mounting portion, at such a distance from the foot-guard brace portion that when the roofing guard device is installed on a roofing surface with lower edge(s) of the lateral brace(s) aligned with a lower edge of the roofing surface, there is substantially no gap between the lower edge of the roofing surface and an edge of an installed foot guard.

Among the additional improvements offered by various aspects and embodiments of the invention is the provision of removable or permanent attachments for fencing structures adapted to prevent roofers and other personnel, and/or their equipment or work materials, from falling off roofs or other structures. Such embodiments can, for example, comprise fixed or removable posts for fixed or removable attachment of sections of paneled fencing, for example through the use of D-rings or other quick links and corresponding grommets, and corresponding fencing and attachment components.

These and further aspects, advantages, and embodiments of the invention are disclosed below, with reference to the attached Figures.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1 and 2 are schematic perspective views of a prior art roofing bracket installation, illustrating some of the shortcomings of the prior art.

FIGS. 3A and 3B are schematic perspective diagrams of roofing guards in accordance with various aspects and embodiments of the invention.

FIG. 4 is a schematic side view of an embodiment of a roofing guard installation in accordance with aspects and embodiments of the invention.

FIGS. 5 and 6 are schematic perspective diagrams of roofing guards in accordance with further aspects and embodiments of the invention.

FIGS. 7-10 are schematic perspective views of embodiments of roofing guard systems in accordance with aspects and embodiments of the invention.

FIG. 11 is a schematic side view of an embodiment of a roofing guard installation in accordance with aspects and embodiments of the invention.

### DESCRIPTION OF EMBODIMENTS

Preferred embodiments of the various aspects of the invention are described through reference to the drawings.

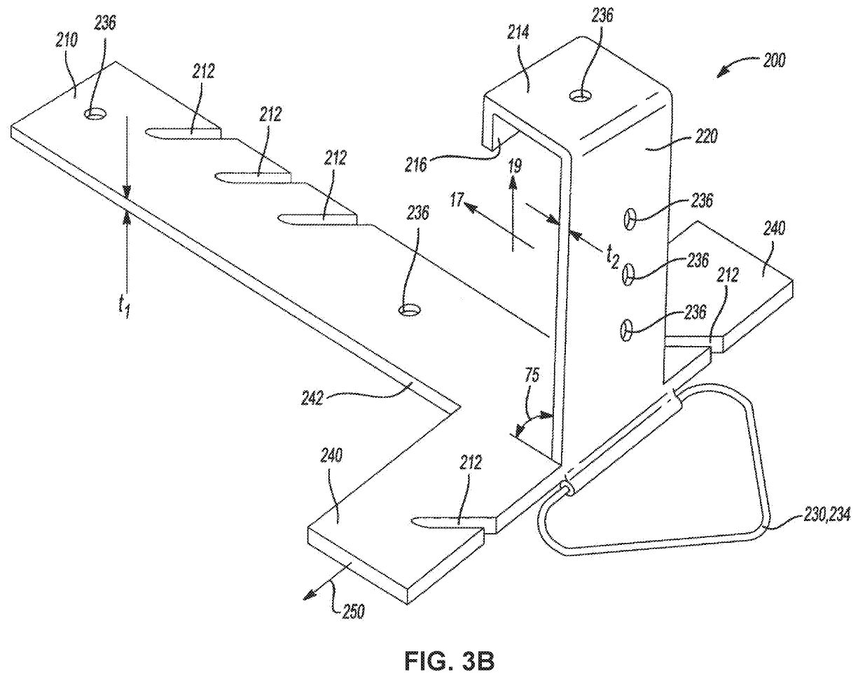

FIGS. 3A and 3B are schematic perspective diagrams of embodiments of roofing guard devices 200 in accordance with various aspects of the invention. In the embodiments shown, roofing guard devices 200 comprise mount portions 210, foot-guard brace portions 220, and fall-arrest safety mounts 230.

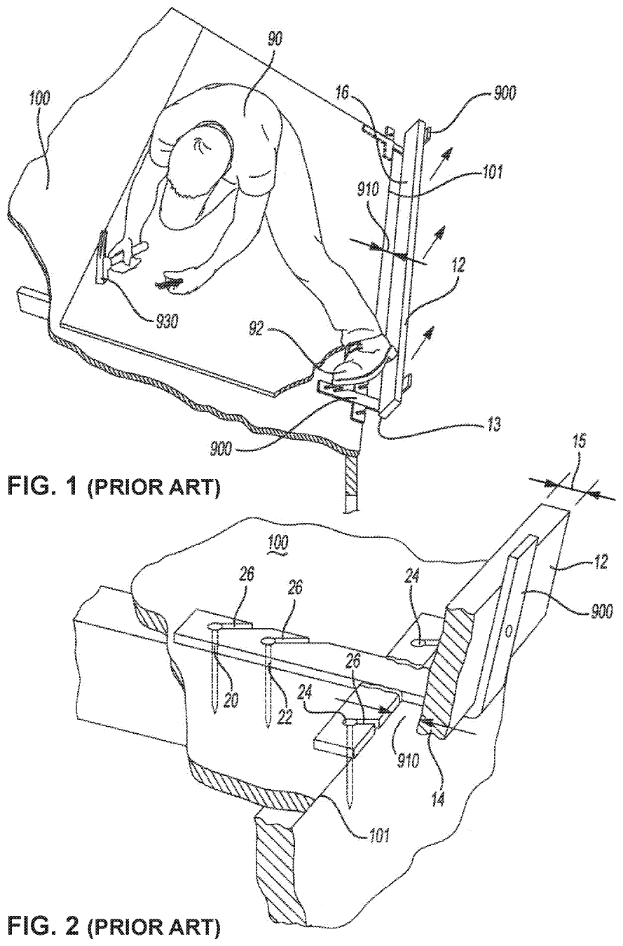

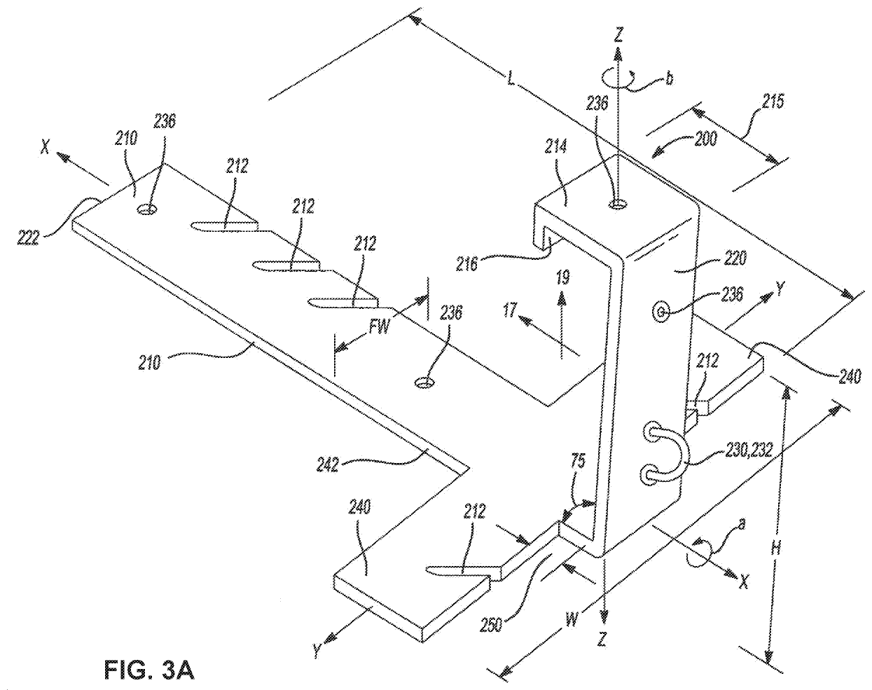

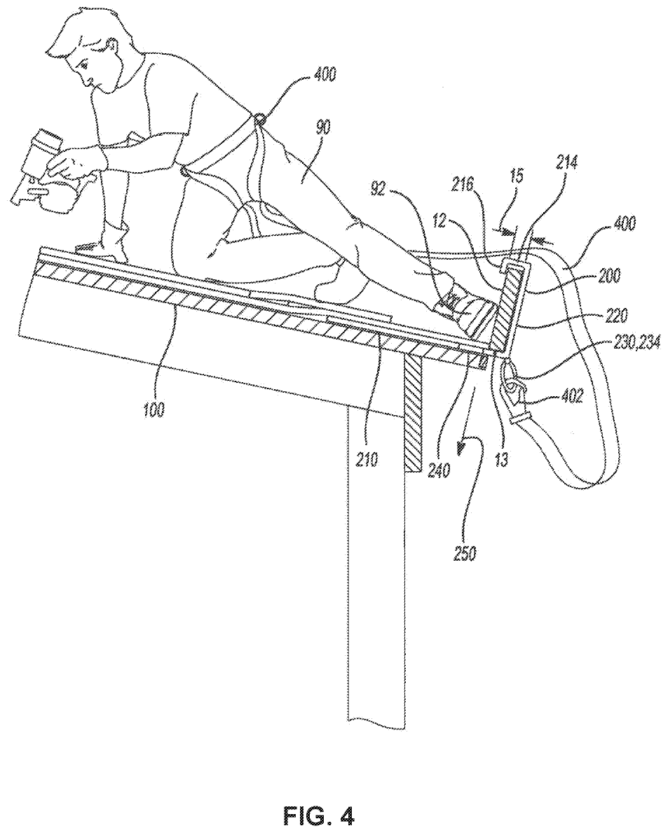

Mount portions 210 of FIGS. 3A and 3B are, in the embodiments shown, adapted for secure attachment, either permanently or releasably, to a roofing surface 100, as shown for example in FIG. 1, by means of slots 212, which are adapted to releasably or permanently receive nails, screws, or other fasteners 20 (FIG. 2) driven into the roofing surface 100. By for example, by not driving or torqueing such nails or screws to the absolute tightness into the roofing surface 100, the rack can be removed by tapping the foot-guard brace portion 220 or any other part of the device 200 with a hammer or other tool 930 (FIG. 1), and thereafter slipping and/or pulling the device 200 from beneath any tar paper, shingles, and/or other coverings that may have been laid atop it (see for example FIG. 4), by causing the device 200 to slide along the fasteners 20 by means of slots 212. Alternatively, if a roofing guard device 200 is to remain in place indefinitely, the screws or nails 20 can be torqued down more firmly, and/or slots 216 may be replaced with holes 236.

In the embodiments shown in FIGS. 3A and 3B, foot-guard brace portions 220 of devices 200 are adapted to permanently or releasably support a foot guard 12 such as a board in a generally or substantially orthogonal relationship with respect to the roofing surface by virtue of their having been configured at approximately a 90-degree angle 15 from the corresponding mount portions 210, by bending or other means. In addition, in the embodiments shown, foot-guard brace portions 220 comprise retainer flanges 214, 216 adapted to restrain the foot guard 12 from lateral movement in directions 17, 19 respectively parallel to and/or orthogonal from the roofing surface 100 while the foot guard 12 is supported by the foot-guard brace portion 220. In the embodiments shown, for example, flange portions 214 are adapted to restrain the foot guards 12 from movement in direction 19, orthogonal to the roofing surface 100; and from movement parallel to the roofing surface 100 in direction 17 by the configuration of flange portions 216. As will be readily understood by those skilled in the relevant arts, foot guards 12 can be restrained from lateral movement in directions opposite to directions 17, 19, by the presence of brace portions 220 and mount portions 210, respectively.

Alternatively, or in addition, foot guards 12 can be restrained from movement in directions 17, 19, etc., by driving nails, screws, or other fasteners into the guards 12 through some or all of holes 236.

In the embodiments shown in FIGS. 3A, 3B, and 4, roofing guards 200 further include a variety of fall-arrest safety mounts 230, which are adapted for different methods of permanently or releasably attaching one or more personnel restraint devices 400, such as a full or partial body harness. In the example shown in FIG. 38, fall-arrest safety mount 230 includes lug 232, which can for example be used to clip or otherwise attach harnesses or other devices 400 of a user 90 to the roofing guard device, as shown for example in FIG. 4. Such safety mounts can provide secure support for a user 90, and/or various tools, etc., by virtue of the fact that mount portion 210 of the guard device 200 is securely attached to the roofing surface 100.

In the embodiments shown in FIGS. 3A and 3B, roofing guard devices 200 can further comprise lateral brace portions 240, which are adapted, when the roofing guard device 200 is attached to a roofing structure 100, to stabilize the roofing guard from movement in lateral directions Y and/or from rotating in directions a, b, about either of axes X, Z as shown in FIG. 3A. In the embodiments shown, a pair of lateral brace portions 240 are provided, in such manner that they extend from the sides 242 of the mount portion 210, proximate the foot-guard brace portion 220 (i.e., closer to the portion 220 than to distal end 222 of the mount portion 210), in a substantially collinear configuration along axis Y-Y.

As noted above, among the improvements provided by the invention is configuration of roofing guard devices 200 in such fashion that gaps between foot guard(s) 12 and roofing surfaces 100 are minimized or eliminated, such that objects dropped on the roofing surfaces are not able to slide or roll along the roofing surface and drop between the foot guard(s) 12 and the roof 100 and fall onto people and other objects below.

This feature can, for example, be implemented by configuring a distance 250 between the lateral braces 240 and the foot-guard brace potion 220 such that, when the roofing guard 200 is attached to the roof surface 100 with a lower edge of the substantially collinear lateral braces 240 substantially aligned with a lower edge 101 of the roofing surface and a foot guard 12 is supported by the foot-guard brace portion, there is substantially no gap between the lower edge of the roofing surface and a lower edge or side 13 (FIGS. 1, 4) of the foot guard 12.

This can be accomplished, for example, by configuring the roofing guard device 200 so that the length or dimension 250 is less than or approximately equal to the width 15 of the foot guard 12 (FIGS. 2, 4) intended for use with the guard device 200. Alternatively, or in addition, the length or dimension 250 can be less than or approximately equal to a length 225 of retention flange 214 (FIG. 3A).

As will be appreciated by those skilled in the relevant arts, the thickness(s) or gauges “t” (FIG. 38) and other dimensions of roofing guard devices 200, and/or the various components or portions 210, 220,214, 216, etc., can be determined by a number of factors, including the applications to which they are to be put, and the loads expected to be supported by them, including the expected number(s) and weight(s) of roofer(s) 90 to be protected by the devices 200, the nature of the tools the roofers are expected to use, the height of the roof 100 from the ground, etc. Selection of suitable dimensions and materials will not trouble those of ordinary skill in the art, once they have been made familiar with this disclosure.

For example, in some currently preferred embodiments roofing devices in accordance with the invention are formed from flat steel sheet of thickness or gauge t of approximately ⅛^{th} inch, with lengths L and W of approximately 12 inches and 6 inches respectively, heights H of approximately 5 inches, and uniform or varied flange widths FW of between 1 and 2 inches (FIG. 3A). Such steel can be of flat sheet or bar stock. Lateral support portions 240, foot-guard brace portions 220, etc., can be integrally formed by suitable trimming and/or bending processes, and/or can be welded or otherwise attached to mount portions 210, etc.

As previously noted, fall-arrest safety mounts 230 can be provided in a very wide variety of configurations, depending upon the desired types of fall-arrest harnesses or systems 400 (FIG. 4) to be used with the devices 200. For example, any varieties of rings 234, lugs 232, and/or other devices can be permanently affixed by welding, integral formation, etc.; and/or they can be removably attached by means of bolts, etc., secured through threaded or unthreaded holes 236. Such devices can be configured to interact with any desired hooks, rings, or other devices 402 of harnesses or other fall-arrest devices or systems 400.

In some presently-preferred embodiments, fall-arrest safety mounts 230 are provided in the form of swiveled rings 234 provided in swivels 235 welded or otherwise permanently attached to any or all of foot-guard brace portion(s) 220, mount portions 210, and/or lateral support portion(s) 240, as shown for example in FIG. 38.

FIG. 4 is a schematic side view of an embodiment of a roofing guard installation in accordance with aspects and embodiments of the invention. FIG. 4 shows an embodiment in which a roofer 90 is at work on a roof 100, with his/her foot 92 braced against a foot guard 12 in the form of a 2×6 wooden plank cradled in brace-support portion 220 by means of flanges 214, 216 in such fashion that the flanges prevent the plank from coming away from the brace portion 220, as described above. For added safety, the roofer 90 is wearing a fall-arrest harness 400, which is attached by a double latch hook mechanism 402 to fall-arrest mount 230, in the form of a D-ring swivel-mounted to the base of the roofing guard device 200, at the junction of mount portion 210 and brace portion 220.

As previously noted, among the improvements offered by various aspects and embodiments of the invention are removable or permanent attachments for fencing structures adapted to prevent roofers and other personnel, and/or their equipment and work materials, from falling off roofs or other structures. Such embodiments can, for example, comprise fixed and/or removable posts for fixed or removable attachment of sections of paneled fencing, for example through the use of D-rings and/or quick links and corresponding grommets; sleeves provided at the ends and intermediate sections and adapted to fit over support posts, etc.

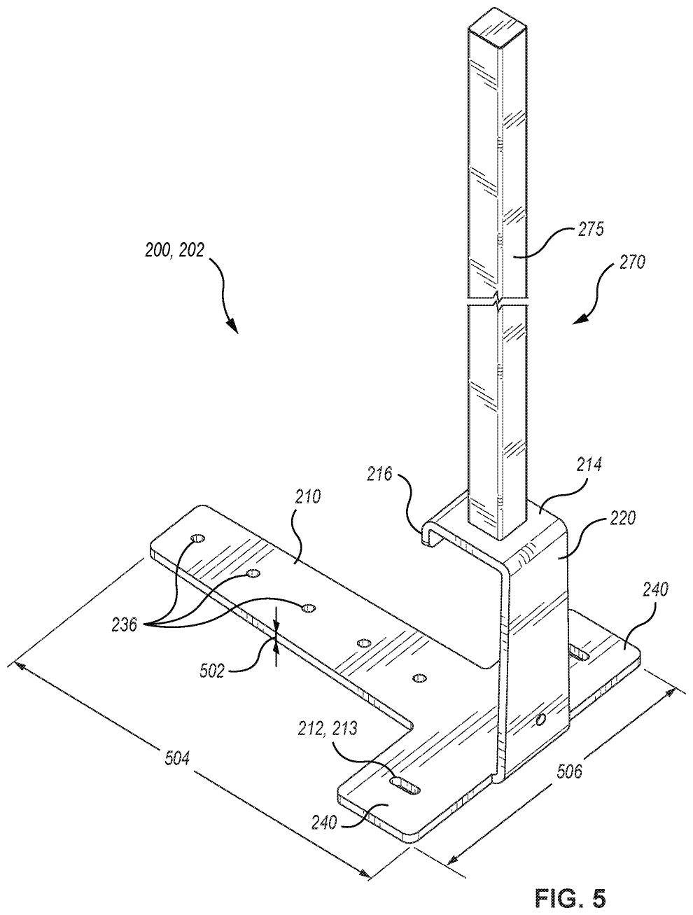

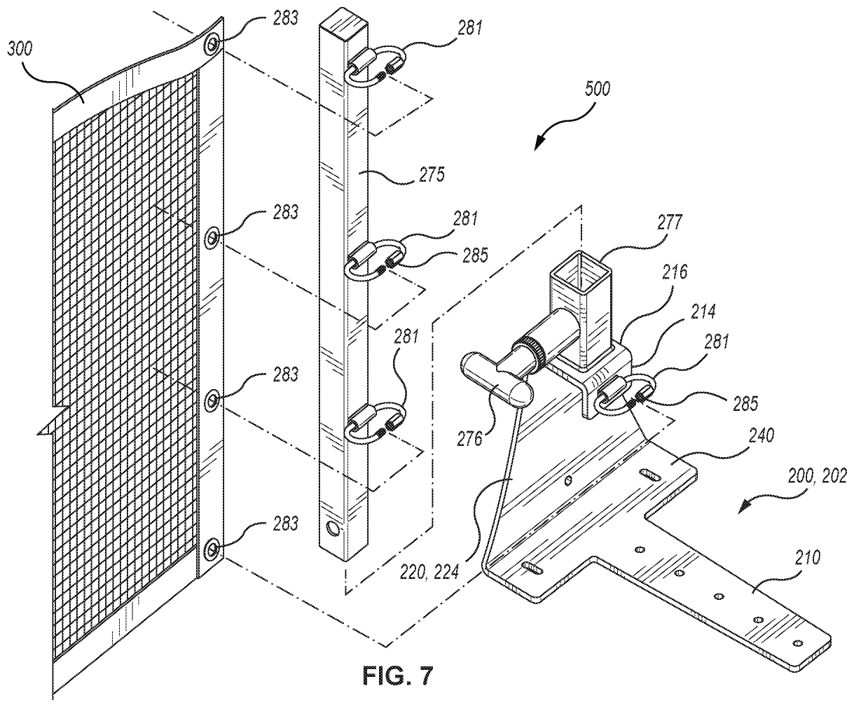

In the embodiment shown in FIG. 5, for example, a roofing guard device 200, 202 comprises mount or retainer portion 210 adapted for permanent or releasable attachment to a sloped roofing surface; foot-guard brace portion 220 with retention flanges 214, 216, adapted to permanently or releasably support a foot guard 12 in a substantially orthogonal or other relationship with respect to the roofing surface; lateral portions 240 attached to each side of mount or retainer portion 210; and fencing post portion 270 comprising fencing post 275 adapted to fixedly or releasably support at least one end of a panel section of fencing 300 (FIG. 7).

In some embodiments of guard devices 200, 202 comprising fencing post portions 270, other components such as mount or retainer portion 210, foot-guard brace portion 220 (including retention flanges 214, 216), and lateral support portions 240 can be configured in accordance with any of the variations described above. Alternatively, some or all of such components may be varied, especially in ways that contribute to the efficiency or effectiveness of such fencing structures or components.

For example, in some embodiments any or all of flanges 210, 220, 240 can comprise holes 236 instead of, or in addition to, one or more slots 212, 213, including such as those shown in FIG. 3A, in order to increase the security with which they are attached to roof structures. As a further example, brace portions 220 can be modified to include widened, reinforced, or otherwise stiffened flanges 220, 224 in order to increase the stability and security of fencing posts 275, etc.

In various embodiments fencing post components 275 can be fixedly or removably attached to roofing guard devices 200, 202. For example, in some embodiments a post 275 can be welded or otherwise fixedly attached to a flange 214, 220, etc. of a device 200, 200, as shown in FIG. 5. As will be understood by those skilled in the relevant arts, a wide variety of means and devices for fixedly attaching fencing posts 275 to roof guard devices 200, 202 in accordance with the invention are known, including for example integral forming, welding, brazing, etc.; and doubtless others will be developed subsequent to this disclosure.

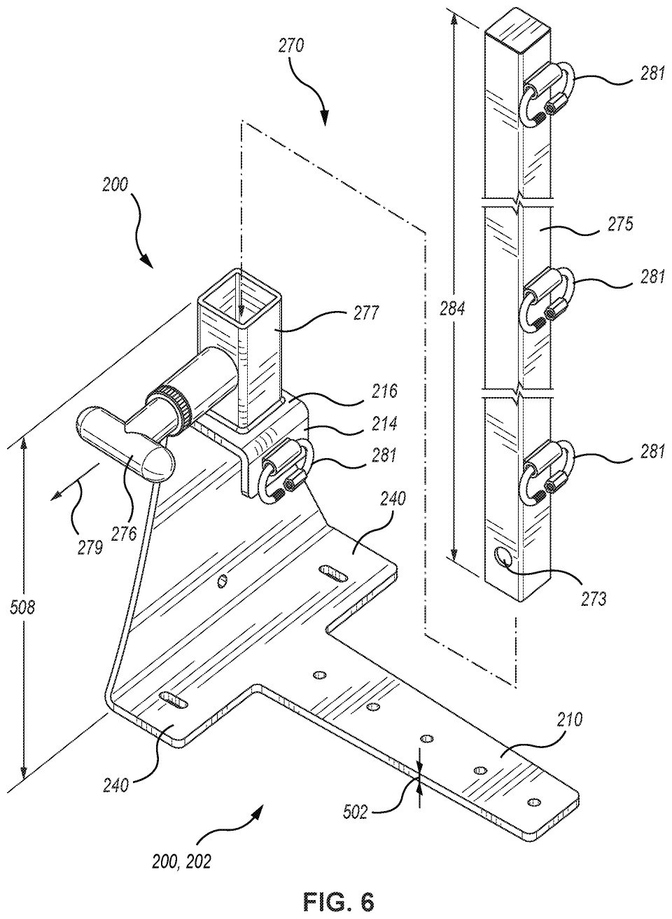

Alternatively, or in addition, post(s) 275 can be removably attached to flange(s) 220, 214, 220, etc., for example by means of one or more bolts and/or spring-loaded detents 276 and sleeves 277. For example, as shown in FIGS. 6 and 7, a roofing guard device 202 consisting of separate base and post portions 202, 275 can be assembled by pulling a handle 278 of a spring-loaded detent mechanism 276 in the direction of arrow 279, inserting a post 275 into a sleeve 277, and releasing the handle 278 such that a biased detent member (not shown) of the mechanism 276 engages one or more holes 273 provided the post 275. In other embodiments, bolts, nuts, etc., can be used for such attachment. As will be understood by those skilled in the relevant arts, a wide variety of mechanisms for providing reliable and secure releasable attachment of fencing post(s) 275 to roof guards 200, 202 are available, and doubtless others will be developed subsequent to this disclosure.

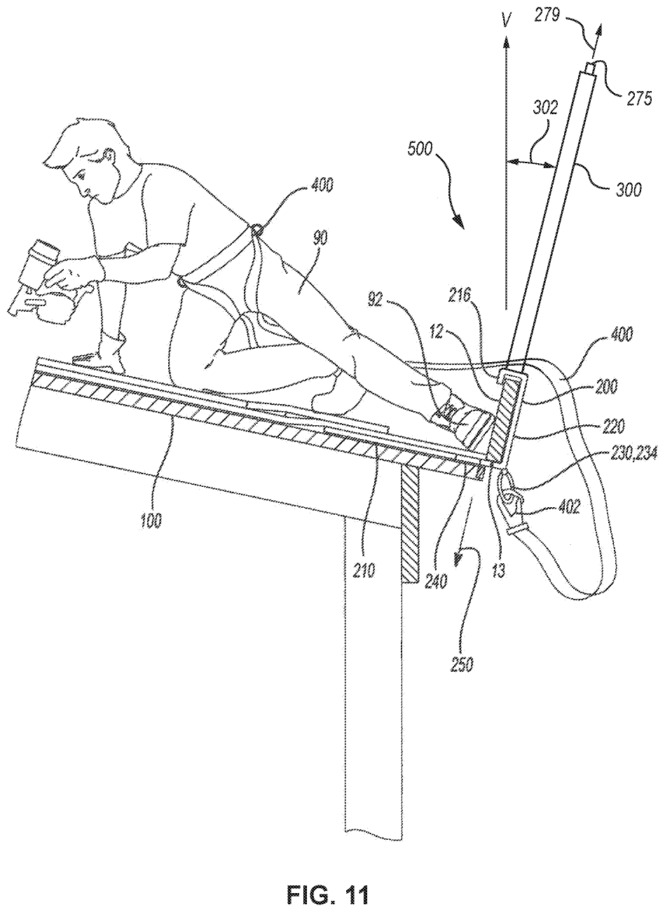

In some embodiments, foot guard devices 202 and/or fencing post(s) 275 can be configured such that when they are installed on roofing surfaces, fencing post(s) 275 and fencing 300 supported thereby are substantially vertical, or substantially normal to the roofing surfaces to which they are attached, or at any other desired orientation with respect to guard device 202 and/or a roof to which the device is attached. For example, as shown in FIG. 11, a foot guard device 202 can be configured so that the post 275 is substantially normal (i.e., substantially orthogonal) to attachment portion 210 of the foot guard 202, so that when used on relatively low-slope roofs (e.g., up to about 40 degrees slope from the horizontal), it is also substantially vertical. In other words, the foot guard can be configured such that the post 275 is within about 40 degrees, and preferably about 20 degrees, of vertical arrow “V” when installed.

In further embodiments, posts 275 can be oriented in substantially horizontal configurations, so as to provide horizontally-extended protection for otherwise falling people or objects.

Of course, by appropriately configuring the angles between attachment flange 210, brass portion 220, and in some embodiments retainer flange 214, any desired angle 302 may be achieved between the longitudinal axis 299 of post 275 and the vertical “V”. Moreover, through the use of spring-biased detents and hinges/hinge plates, etc., a range of angles 302 can be provided and easily and securely selected by a roofer or other operator.

Fencing or fence section(s) 300 can be attached to one or more posts 275 in any ways suitable for use in implementing the various improvements disclosed herein. For example, fencing 300 can be provided in the form of single panels, for permanent or removable attachment between pairs of guard devices 202 only, or in the multi-panel forms, for permanent or removable attachment to larger numbers of devices 202. Many forms of removable and/or permanently attached fencing sections 300 suitable for implementing the invention exist, and doubtless others will be created subsequent to this disclosure.

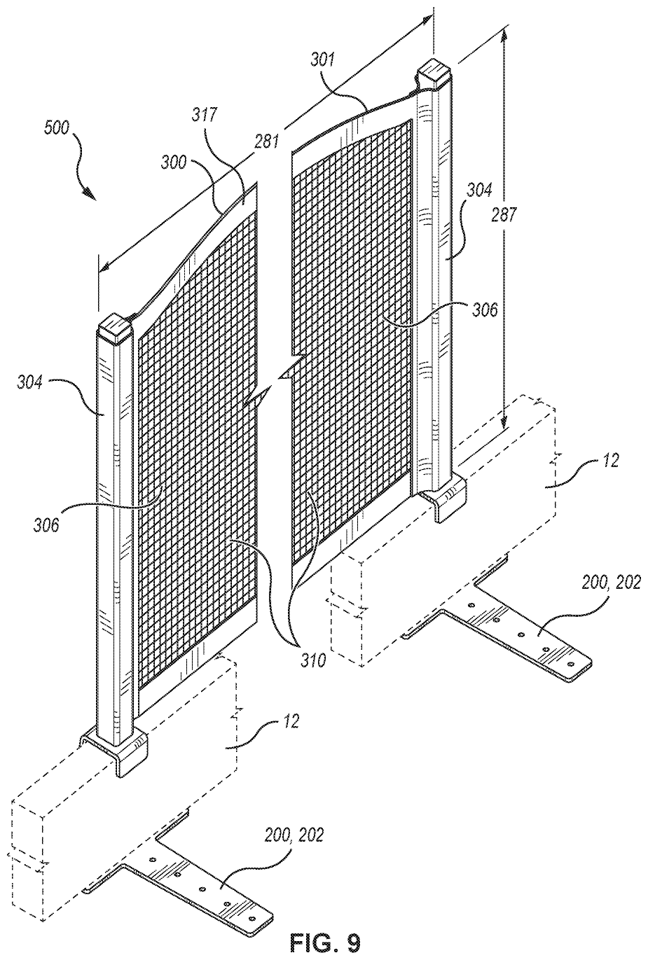

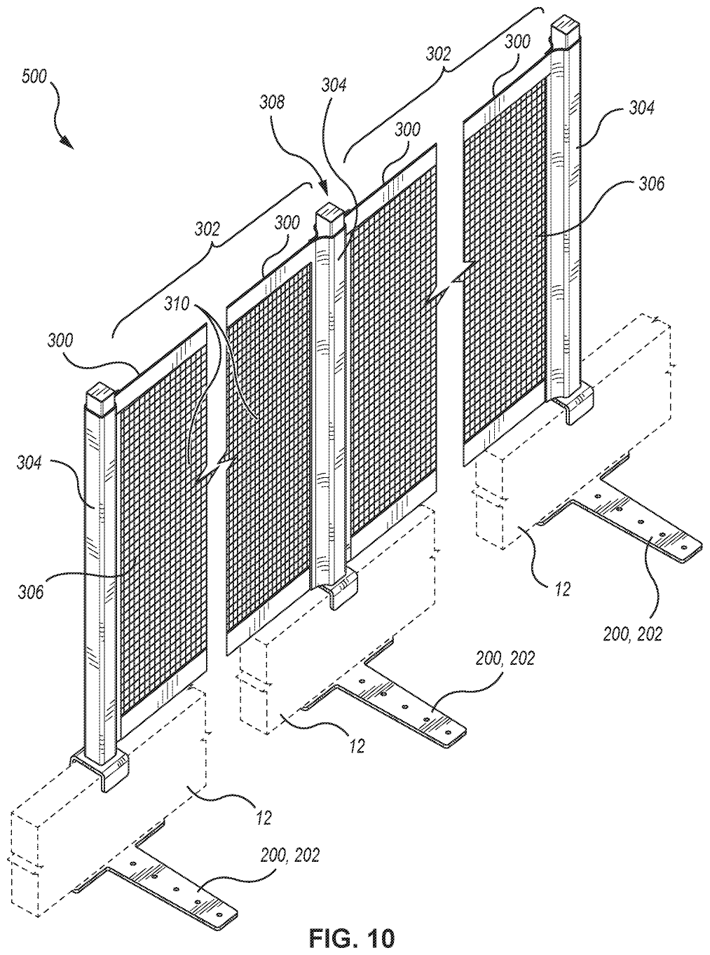

For example, as shown in FIGS. 9 and 10, any desired numbers of fencing sections or panels 300, 302 can be conveniently, removably, and securely attached to any desired numbers of posts 275 through the provision of sleeves 304 adapted to for sliding reception of posts 275 at edges 306 or in any desired intermediate locations 308 of panels 300. Such sleeves may be fabricated using, for example, any appropriate types of materials, such as high-strength polyester fibers, stitched to suitable netting materials, solid canvas or other fabric panels, etc.

Alternatively, or in addition, any of a wide variety of alternative devices may be used to fixedly or removably attach fencing/panels 300 to posts 475 and other components of roofing systems in accordance with the disclosure. As shown, for example, in FIGS. 6, 7, and 8, various forms of D-rings, snap-locks, snaps, buckles and/or other forms of quick links or secure, releasable attachments 281 such as bolts and lugs may be provided on any or all of flange(s) 220, 224, 214, 216, post support(s) 277, post(s) 275, and net sections 300, for engagement with corresponding rings, grommets, or other retaining structures 283 on counterpart structures. In the examples shown in FIGS. 6, 7, 8, D-ring quick links 281 can by unscrewing retainer nuts 285 to open the ring, placing grommets 283 within the ring, and re-screwing the retainer nuts to secure the fencing sections 300.

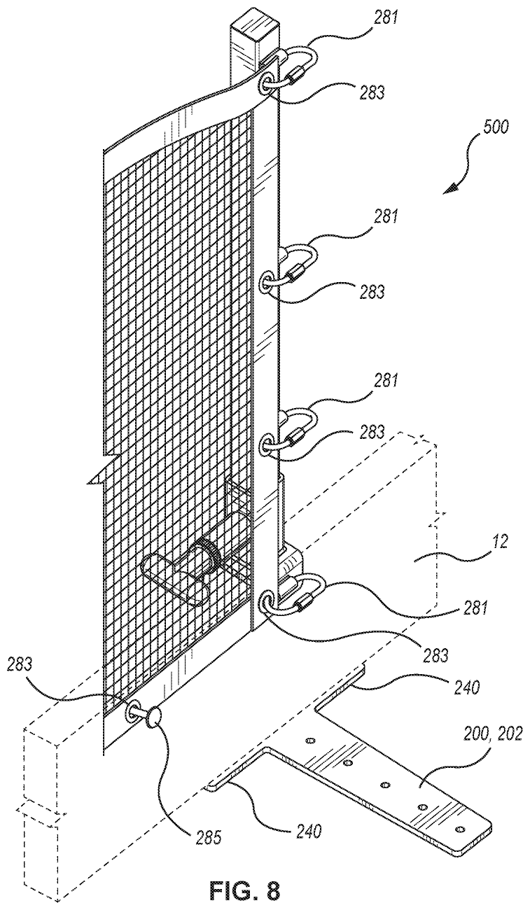

Alternatively, or in addition, some or all of panels 300 may be fixedly attached to posts 375, guard devices 200, 202, and or foot braces 12. For example, as shown in FIG. 8, screws, nails, snaps, buckles, and/or other forms of fixed or removable attachment may be employed.

Thus, as will be appreciated by those skilled in the relevant arts, many forms of removable and/or fixed attachment of fencing sections 300 to roof guard devices 200, 202, 12, etc., currently exist, and doubtless further suitable devices will be created subsequent to this disclosure.

Thus in various aspects and embodiments the invention provides foot guard and fencing assemblies 500 comprising pluralities of foot guard and fencing devices 200, 202, and one or more fencing panels or sections 300, each fencing panel or section 300 comprising a web portion and two ends, each end comprising a sleeve configured to receive a fencing post of one of the plurality of foot guard and fencing devices. In some embodiments, such assemblies comprise one or one fencing panels 300 having one or more grommets or other devices 283 for attaching the fencing panels 300 to a foot brace 12 disposed between two fencing posts 275.

In the same or other embodiments, such guard and fencing assemblies 500 can be configured for removable or releasable attachment of fencing portions 300 to fencing posts 375 and/or other components 200, 202, 214, 216, 12 by means of attachments 281, 283, 285, etc., in addition to or as an alternative to the use of sleeves.

It will be appreciated by those skilled in the relevant arts that devices 200, 202, and assemblies 500 in accordance with the invention can be provided in a variety of modular forms, leaving it to the discretion of the individual roofer or other user 90 to add as many nets 300 as they require for each application. For example, in a commercial embodiment assemblies might be sold in sets of 4 guard devices 200, 202, allowing for use of 3 net panels 302, any additional desired lengthening to be accomplished through the purchase or other acquisition of additional sets 500. Through the use of such systems or sets 500 any edges, precipices, or other otherwise unprotected drop-offs may be protected from falling personnel and objects, and increased protection for pedestrians and others below such workplaces from falling objects or materials.

Various materials and exemplary dimensions are set out above. As will be understood by those skilled in the relevant arts, a very wide variety of material and dimensions will be appropriate for use in implementing the improvements described herein, depending on factors such as the nature of the roofs to be worked upon; the height of roofing works above the ground; the sizes, weights, and numbers of roofing workers, tools, and materials to be protected by the systems; and the nature of materials available. A wide variety of metals, plastics, polymers, and natural fibers will serve, depending on the context of use. In an example roofing guard system 500 adapted for the support of safety nets 300 on a residential or commercial roof having roofing joists spaced at, for example, 26 inches, the following exemplary dimensions may be used in fabrication:
For guard devices (or brackets) 200, 202, as shown in FIGS. 5 and 6, gauge 502 of ¼ inch thick carbon steel bracket, with length 504 of 8% inches, width 506 of 7 inches, & height 508 of 8¼ inches (including 1¼×2-inch square tubing welded to the top for a fixed locking system 276, 277).
¼ inch diameter shaft spring loaded locking mechanism 276, and pull pop pin. Welded to square tubing on top of bracket allowing for quick release and application of net posts.
Post 275 of 1-inch square steel tubing, of height 284 of 14-40 inches with a plastic 1×1 cap 286. This post is where the quick links 281 are fastened and is slotted through the previous mentioned 1¼×2-inch square tubing 277 on top of the bracket 200, 202.
⅛th inch diameter quick links 281 are fastened to the posts 275 via keepers or retainers 285, allowing for safety and flexibility in the netting system. They can be installed 4 per bracket (3 on the post and 1 on the top of the bracket 220, 214). This system allows for ease of removal and application of the netting via grommet 283.
15-41 inch net height 287, to match posts 275, with net or net section 300 of length 291 of 31-80 inches, with 1-inch canvas, nylon, or other border 317. The net web 310 and/or boarder 317 can be of polyvinyl chloride (PVC)-coated polyester fabric and/or mesh for increased durability & UV protection. Can comprise 4 grommets 283 on either end and 1 grommet 283 in the border 317 at the bottom for application to posts 275 via quick link and the ability to screw/nail in bottom grommet 283 to toe-board 12. This netting acts as an extended toe-board system and is meant, for example, to stop objects that could roll over the traditional wood plank toe-board.
Optional 2/4, 2×6, or other wood plank 12 can be applied to the bottom of the bracket 200, 202 and fastened via nail or screw, in order to act as a toe-board. This allows for ease of movement while on the roof and can hold light hand tools & materials.

As will be understood by those skilled in the relevant arts, fencing webs 310 can be of net or solid fabric form, depending on factors such as available materials, system purposes, and fencing dimensions, and can be formed of natural or artificial fibers in sheet or net form.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

1. A foot guard and fencing device for use on a sloped roof, comprising:
a retainer portion adapted for permanent or releasable attachment to a sloped roofing surface;
a foot-guard brace portion adapted to permanently or releasably support a foot guard in a substantially orthogonal or relationship with respect to the roofing surface,
a fencing post portion comprising a post adapted to support at least one end of a panel of fencing, and
at least one lateral brace portion attached to each side of the retainer flange.

2. The foot guard and fencing device of claim 1, wherein the post is fixedly attached to the fencing post portion.

3. The foot guard and fencing device of claim 1, wherein the fencing post portion comprises a post support device configured for removable attachment of the post.

4. The foot guard and fencing device of claim 3, wherein the device configured for removable attachment of the post comprises one or more spring detent mechanisms.

5. The foot guard and fencing device of claim 1, wherein the fencing post portion is configured to support the post in a substantially vertical orientation.

6. The foot guard and fencing device of claim 1, wherein the fencing post portion is configured to support the post in an orientation that is substantially normal to a roofing surface to which the foot guard and fencing device is attached.

7. The foot guard and fencing device of claim 1, wherein the fencing post portion comprises one or more devices for removable attachment of fencing.

8. The foot guard and fencing device of claim 7, wherein the one or more removable devices for attachment of fencing comprise one or more quick links adapted for attachment of grommets of a fencing panel.

9. A foot guard and fencing assembly comprising:
a plurality of foot guard and fencing devices in accordance with claim 1; and
at least one fencing panel, each fencing panel comprising a web portion and two ends, each end comprising a sleeve configured to receive a fencing post of one of the plurality of foot guard and fencing devices.

10. The foot guard and fencing assembly of claim 9, wherein at least one fencing panel comprises one or more devices for attaching the at least one fencing panel to a foot brace disposed between two fencing posts.

11. The foot guard and fencing assembly of claim 10, wherein the one or more devices for attaching the fencing panel to a foot brace comprises one or more grommets.

12. A foot guard and fencing assembly comprising:
a plurality of foot guard and fencing devices in accordance with claim 1; and
at least one fencing panel, each fencing panel comprising a web portion and two ends, each end comprising one or more devices for removable attachment of the panel to a fencing post.

13. The foot guard and fencing assembly of claim 12, wherein the one or more devices for removable attachment of the fencing panel to a fencing post comprise one or more
a plurality of foot guard and fencing devices in accordance with claim 1; and
at least one fencing panel, each fencing panel comprising a web portion and two ends, each end comprising one or more attachment points for D-ring attachment devices.
